(19) United States
(12) Patent Application Publication
(10) Pub. No.: US 2004/0268404 A1
(43) Pub. Date: Dec. 30, 2004

(54) System and method for message notification

(76) Inventors: James Harold Gray, Ellijay, GA (US); Thomas Jefferson Brothers, Gainesville, GA (US); William Randolpoh Matz, Atlanta, GA (US)

Correspondence Address: BELLSOUTH CORPORATION, P.O. BOX 2903, MINNEAPOLIS, MN, 55402-0903, US

(21) Appl. No.: 10/611,455

(22) Filed: Jun. 30, 2003

(51) Int. Cl. H04N 7/173; G06F 13/00; H04N 5/445; G06F 3/00; H04N 7/10; H04N 7/025

(52) U.S. Cl. 725/112; 725/34; 725/35; 725/109; 725/110; 725/111

(57) ABSTRACT

A method and apparatus are described that provide message notification to users of an interactive television service. According to one aspect of the present invention, a method comprises determining whether to inform a user of the interactive television service of receipt of an email message. Responsive to determining to inform the user of the receipt of the email message, a hot key signal is generated indicating availability of the email message. The hot key signal is inserted into a content signal transmitted to the user from the interactive television service provider via a network. Once the hot key signal is received, a determination is made whether the hot key signal is relevant to the user. Responsive to determining the hot key signal is relevant to the user, an indication that the hot key signal has been received is displayed on a screen.

### RELATED APPLICATIONS

This application is related to co-pending application Ser. No. ______ filed on Jun. 30, 2003.

### FIELD OF THE INVENTION

The various embodiments of the invention disclosed herein relate generally to the field of interactive television. More particularly, these embodiments relate to providing message notification to users of an interactive television service.

### BACKGROUND OF THE INVENTION

Advances in telecommunications and computing technology have led to the use of interactive television (TV) services on a large scale. Where such services are available, users are not only able to access television content by passively receiving it, but are also beginning to interact with the service providers by communicating requests and/or commands to the service providers. These requests and/or commands may be communicated to the service provider via the same path over which the programming services are provided or even via other paths.

Interactive television may be provided over any number of paths, including coaxial cable or optical fiber, hybrid fiber/coaxial, or any other suitable path that accommodates sufficient bandwidth for desired video channels as well as other telecommunications services. Content providers may include, for example, providers of over-the-air programming such as commercial television stations, cable programming such as weather, travel and entertainment channels, game channels, and other interactive services of various types.

Generally, TV service provides a user or users with a variety of options such as: traditional broadcast and cable television programming; video services, such as pay-per-view (PPV), near video-on-demand (NVOD), video-on-demand (VOD), promo channels, electronic program guides, etc.; cable delivered PC-based services; and interactive services through the use of a combination of compression and digital video technologies. TV services may also provide menuing capabilities and upstream signaling from users to service providers.

The combination of broadcast and interactive applications over interactive TV (e.g., interactive content) creates a possible mode of communication in which a user, if informed of the availability of alternate interactive content relating to a subject matter of interest, may invoke the alternate content to investigate that subject matter more thoroughly and according to his or her own tastes. However, television viewers, who are accustomed to choosing at will between the available transmitted channels with instantaneous results, will expect to be informed of the alternate content in a convenient and timely manner and to pass from one medium to another seamlessly.

### SUMMARY OF THE INVENTION

A method and apparatus are described that provide message notification to users of an interactive television service. According to one aspect of the present invention, a method comprises determining whether to inform a user of an interactive television service of receipt of an email message. Responsive to determining to inform the user of the receipt of the email message, a hot key signal is generated indicating availability of the email message. The hot key signal is inserted into a content signal transmitted to the user from an interactive television service provider via a network with which the user and the interactive television service provider are connected.

According to another aspect of the present invention, a method comprises receiving a hot key signal indicating receipt of an email message by a Post Office Protocol (POP) account of a user of an interactive television service. A determination is made whether the hot key signal is relevant to the user. Responsive to determining the hot key signal is relevant to the user, an indication that the hot key signal has been received is displayed on a screen.

Other features of the present invention will be apparent from the accompanying drawings and from the detailed description that follows.

### BRIEF DESCRIPTION OF THE DRAWINGS

The appended claims set forth the features of embodiments of the invention with particularity. The invention, together with its advantages, may be best understood from the following detailed description taken in conjunction with the accompanying drawings of which:

FIGS. 1A-1D illustrate a television displaying a picture containing a hot key for informing a user of available email and providing the user with the email responsive to selection of the embedded hot key according to one embodiment of the present invention;

FIG. 2 is a block diagram illustrating an exemplary network over which interactive television signals containing embedded hot key signals may be transmitted according to one embodiment of the present invention;

FIG. 3 is a block diagram of a head-end and data center system where hot key signals may be added to a transmitted signal according to one embodiment of the present invention;

FIG. 4 is a flowchart illustrating head-end and data center processing for adding hot key signals to a transmitted signal according to one embodiment of the present invention;

FIG. 5 is a diagram illustrating one possible format for a hot key data packet according to one embodiment of the present invention;

FIG. 6 is a block diagram of a user side system to provide a user with an email message responsive to selection of an embedded hot key according to one embodiment of the present invention; and

FIG. 7 is a flowchart illustrating processing on a user side system for providing a user an email message responsive to selection of an embedded hot key according to one embodiment of the present invention.

### DETAILED DESCRIPTION OF THE INVENTION

In the following description, for the purposes of explanation, numerous specific details are set forth in order to provide a thorough understanding. It will be apparent, however, to one skilled in the art that embodiments of the present invention may be practiced without some of these specific details. In other instances, well-known structures and devices are shown in block diagram form.

Embodiments of the present invention include various processes, which will be described below. The processes may be performed by hardware components or may be embodied in machine-executable instructions, which may be used to cause a general-purpose or special-purpose processor or logic circuits programmed with the instructions to perform the processes. Alternatively, the processes may be performed by a combination of hardware and software.

Embodiments of the present invention may be provided as a computer program product which may include a machine-readable medium having stored thereon instructions which may be used to program a computer (or other electronic devices) to perform a process. The machine-readable medium may include, but is not limited to, floppy diskettes, optical disks, Compact Disk Read-Only Memories (CD-ROMs), and magneto-optical disks, Read-Only Memories (ROMs), Random Access Memories (RAMs), Erasable Programmable Read-Only Memories (EPROMs), Electronically Erasable Programmable Read-Only Memories (EEPROMs), magnetic or optical cards, flash memory, or other type of media/machine-readable medium suitable for storing electronic instructions. Moreover, embodiments of the present invention may also be downloaded as a computer program product, wherein the program may be transferred from a remote computer to a requesting computer by way of data signals embodied in a carrier wave or other propagation medium via a communication link (e.g., a modem or network connection).

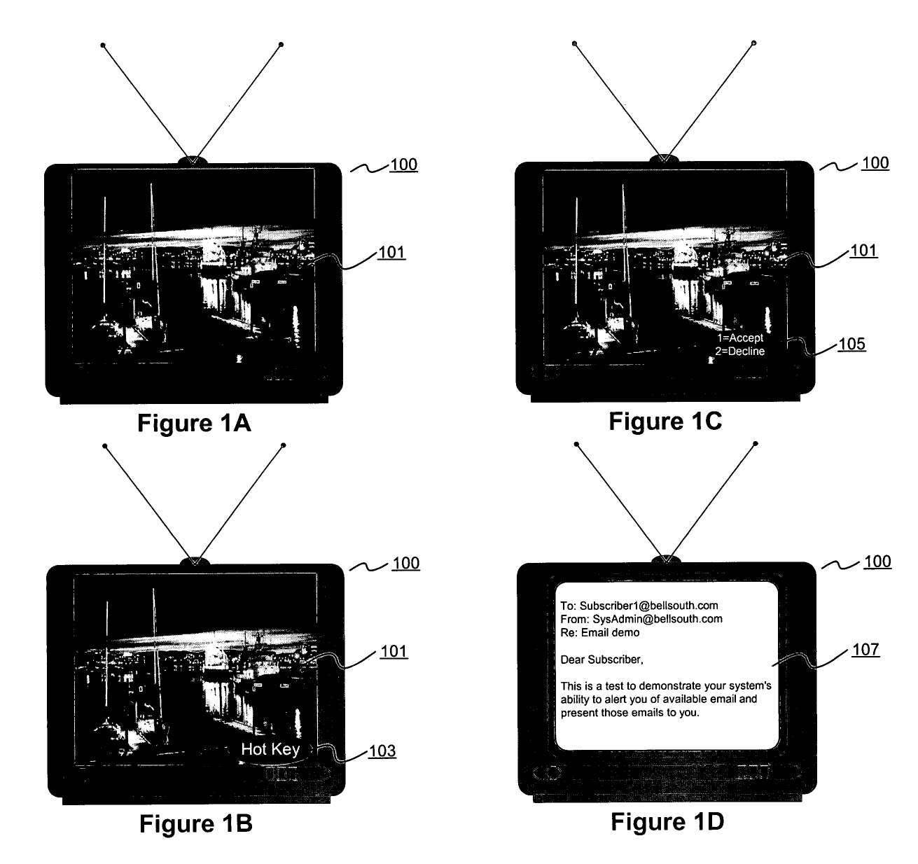

FIGS. 1A-1D illustrate a television displaying a picture containing a hot key for informing a user of available email and providing the user with the email responsive to selection of the embedded hot key according to one embodiment of the present invention. These figures represent respectively a process of viewing content, receiving a hot key, accepting a hot key, and presenting an email message.

Specifically, FIG. 1A illustrates an example of viewing content. Here, a video program 101 is being displayed on television 100. Alternatively, a user may be viewing other types of interactive TV content such as pay-per-view video content, interactive games, etc.

FIG. 1B illustrates an example of receiving a hot key. In this example, the user is tuned to the same video program 101 on television 100 as in the previous example of FIG. 1A. However, in this example an icon 103 or other graphic has been displayed to indicate to the user that a hot key has been received. The hot key indicates that an email message has been received by the user's email account. As will be described below, the email account may be one provided by the interactive TV service provider or by a third party such as an Internet Service Provider (ISP).

FIG. 1C illustrates an example of accepting a hot key. In this example, the user is tuned to the same video program 101 as in FIGS. 1A and 1B. Icon 105, displayed to indicate to the user that a hot key has been received, now indicates a manner in which the user may accept or decline the hot key. In this example, icon 105 indicates that the user may press 1 to accept the hot key or 2 to decline the hot key. Accepting the hot key causes the email message to be temporarily displayed to the user. Declining the hot key allows the user to temporarily ignore the email message and read the message at a later time.

Of course, other methods of accepting or declining the hot key may be used. For example, different single or even multiple buttons on a remote control may be pressed by the user to accept or decline the hot key. According to one embodiment, a single “hot key button” may be present on the user's remote control that may be pressed by the user whenever a hot key icon is present on the television display. Pressing the hot key button may be a manner in which the user accepts the hot key and is presented with the email message without further interaction from the user. According to another embodiment, the user may decline the hot key by taking no action at all. That is, after some time period during which no action is taken by the user to accept the hot key, the hot key may simply time out and expire. Various other methods of accepting or declining the hot key may also be used.

Regardless of the exact operation used to accept the hot key, FIG. 1D illustrates presenting an email message to a user responsive to the hot key being accepted. In this example, television 100 displays an email message 107. According to one embodiment of the present invention, the email message 107 may be presented in a full screen against a blank background. Alternatively, the email 107 may be superimposed on the original content display, presented in a picture-in-picture display, scrolled across a textbox at the bottom or top of the display, etc.

A system over which interactive television signals containing embedded hot key signals may be transmitted according to various embodiments of the present invention may occur over different types of networks. These different types of networks include, but are not limited to, cable, satellite, Fiber-to-the-Curb (FTTC), Fiber-to-the-House (FTTH), Very high speed Digital Subscriber Line (VDSL), and others.

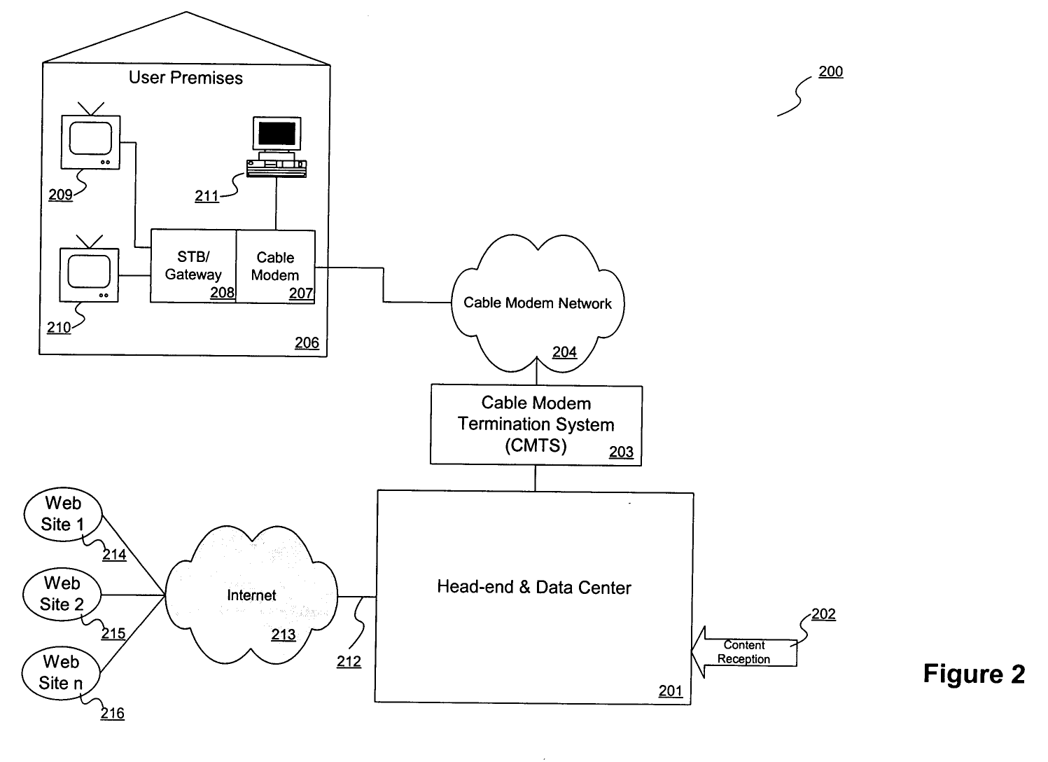

FIG. 2 is a block diagram illustrating an exemplary network over which interactive television signals containing embedded hot key signals may be transmitted according to one embodiment of the present invention. This example illustrates, at a high-level, an architecture of a service provider's system 200 that includes head-end and data center 201, Cable Modem Termination System (CMTS) 203, cable modem network 204, and user premises 206 that also contains cable modem 207, Set Top Box (STB)/Gateway 208, one or more televisions 209 and 210, and possibly other devices such as personal computer (PC) 211.

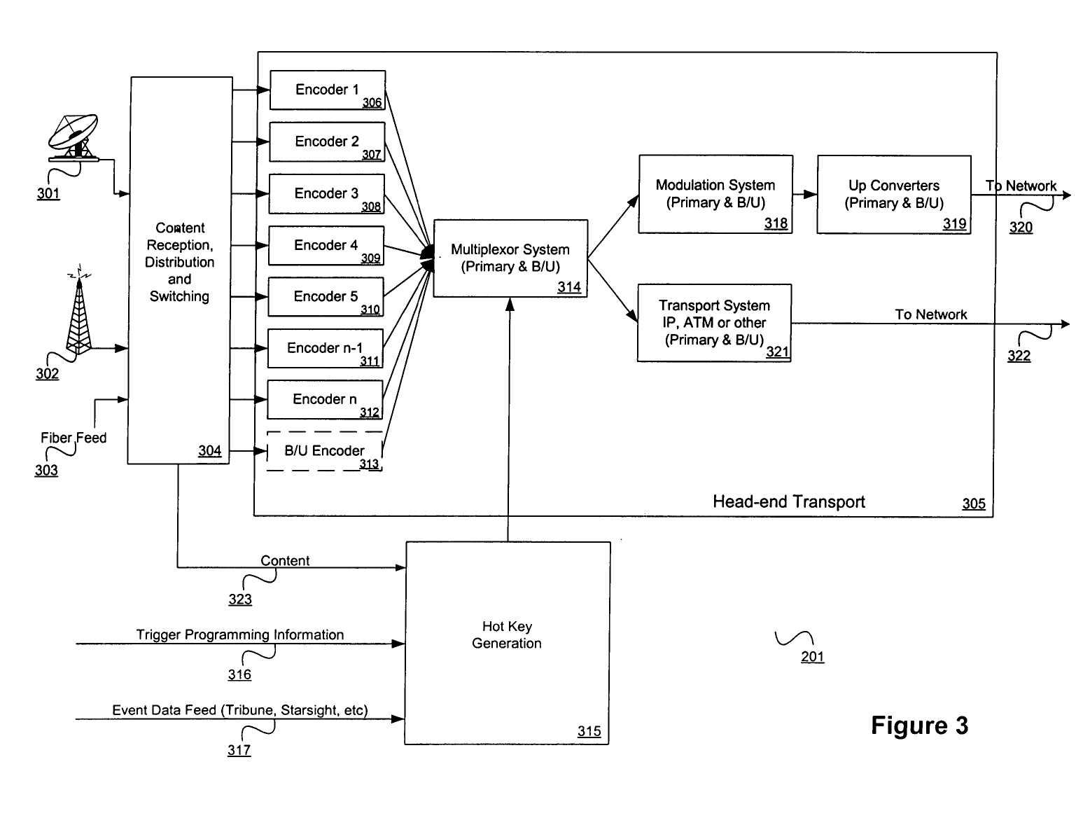

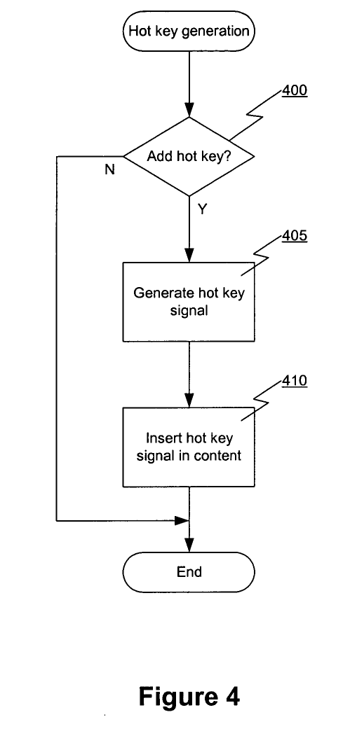

An interactive TV service provider typically operates and maintains a head-end and data center 201 equipped to receive signals 202 from one or more content providers. Content providers may be any original or secondary source of programming or information generally including, for example, interactive or non-interactive over-the-air programming such as commercial television stations, cable programming such as weather, travel and entertainment channels, game channels, and other interactive services of various types. Head-end and data center 201, after receiving content from one or more content providers, may then transmit the interactive content to users premises 206. Further details of the hardware comprising the head-end and data center 201 as well as the processing performed therein will be discussed below with reference to FIGS. 3 and 4.

According to one embodiment of the present invention, hot key signals indicating the availability of email messages to a user may be generated at head-end and data center 201. For example, the hot key signals may be generated at head-end and data center 201 by polling the user's Post Office Protocol (POP) account and generating a hot key signal to that user whenever a new message has been received by the POP account. As will be discussed below, these embedded hot key signals are transmitted from head-end and data center 201 and are received and used by STB/gateway 208 or PC 211 at user premises 206 to inform the user of the availability of an email message and to present the user with this message if he chooses to accept it.

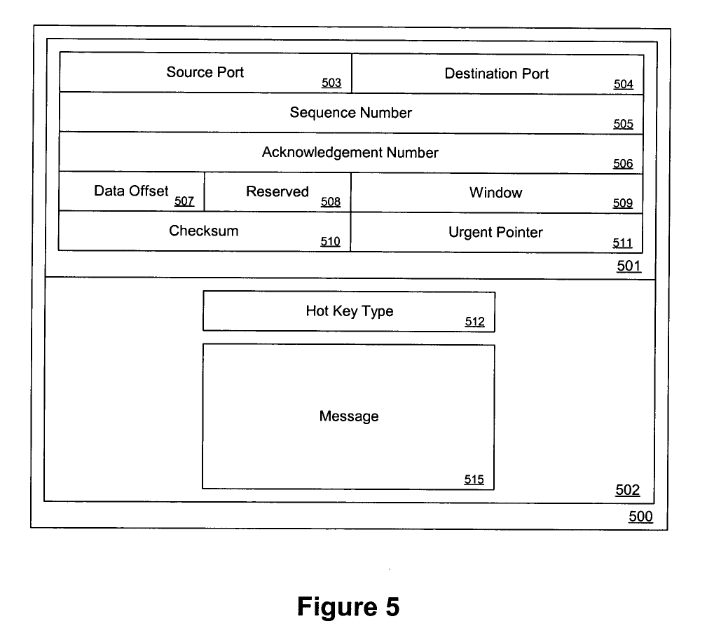

In the example illustrated in FIG. 2, a signal carrying interactive TV content is transmitted from head-end and data center 201 through CMTS 203 and onto cable modem network 204. Typically, transmissions over cable modem network 204 may be made in a digital form. For example, the content may be transmitted as a Motion Pictures Experts Group Standard 2 (MPEG-2) data stream using a network protocol such as Internet Protocol (IP). Therefore, the content may be transmitted from head-end and data center 201 as IP data packets or in another similar format. One possible example of such a packet will be discussed below with reference to FIG. 5.

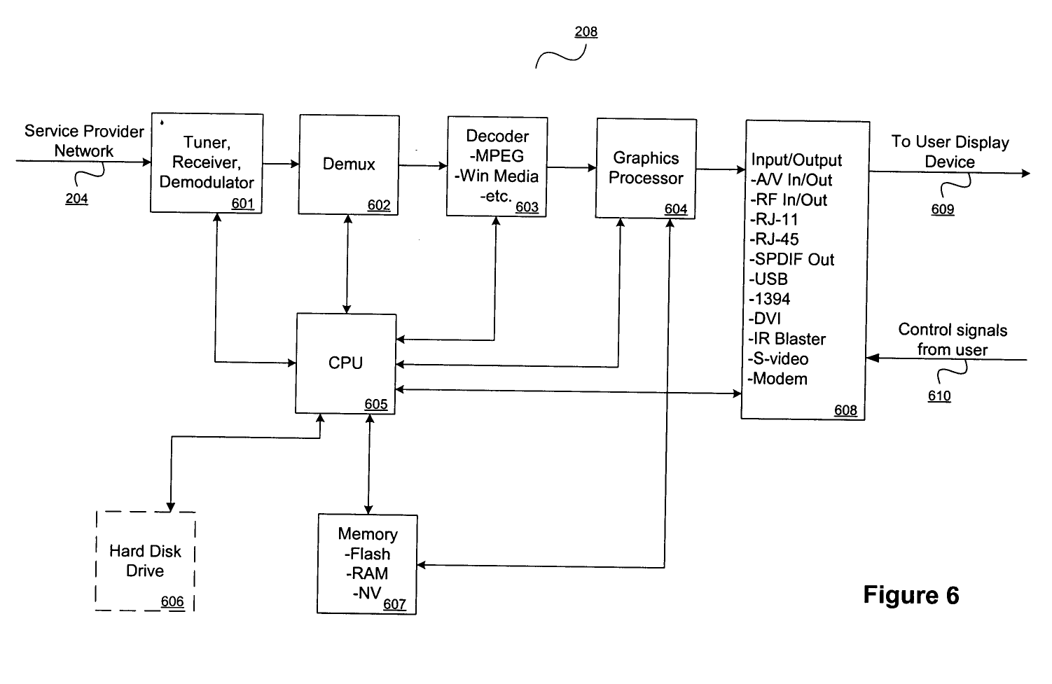

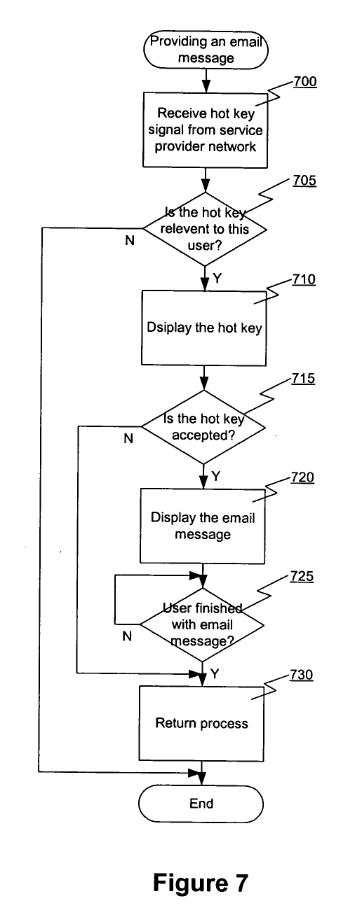

Regardless of the format of the transmission, a signal carrying the interactive TV content is received at user premises 206 via cable modem 207. Connected with cable modem 207 may be some form of terminal device. In the example illustrated by FIG. 2, two possible types of terminal devices, STB/Gateway 208 and PC 211 are shown. The terminal device, STB, Gateway, PC or other device, performs functions such as exchanging messages (including video-related data) over a network with head-end and data center 201, receiving messages from a user input device, such as a hand-held remote control unit or keyboard, translating video signals from a network-native format into a format that can be used by televisions 209 and 210 or other display devices, and providing a video signal to televisions 209 and 210 or other display devices. STB/Gateway 208 and PC 211 may also be capable of performing other functions, such as inserting alphanumeric or graphical information into the video stream in order to “overlay” that information on the video image, providing graphic or audio feedback to a user, or routing a traditional transmission signal to a viewing device to which another STB is connected. Additional details of the hardware of STB/Gateway 208 and the processing performed therein will be discussed below with reference to FIGS. 6 and 7.

In use, STB/Gateway 208 or PC 211 may receive hot key signals embedded in the interactive TV signals by either the content providers or the service provider. STB/Gateway 208 or PC 211 may then notify the user of available email messages as discussed above with reference to FIG. 1. STB/Gateway 208 or PC 211 may then receive some form of user feedback indicating that the user accepts or declines the hot key. If the user accepts the hot key, STB/Gateway 208 or PC 211 may then present the email message to the user as will be discussed further below with reference to FIG. 7.

According to one embodiment of the present invention, head-end and data center may also be connected with the Internet 213 or other network via a high-speed connection 212 such as a fiber optic connection to provide access to a number of web sites 214-216. Also, through this connection 212, head-end and data center 201 may supply hot key signals informing a user of emails to a POP account maintained by another service provider if the user has provided access to this account.

FIG. 3 is a block diagram illustrating a head-end and data center system where hot key signals may be added to a transmitted signal according to one embodiment of the present invention. This example illustrates head-end and data center system 201 comprising content reception, distribution, and switching portion 304, head-end transport portion 305, and hot key generation system 315.

Content reception, distribution, and switching portion 304 is connected with one or more of satellite receiver 301, over the air broadcast receiver 302, fiber optical feed 303, and other types of links (not shown) to receive signals from one or more content providers. Content reception, distribution, and switching portion 304 comprises equipment that that is commonly used to receive transmitted signals, demodulate the transmitted signals to separate the content signals from a carrier signal if necessary, distribute and arrange the content from the content providers to fit a programming schedule of the service provider, and provide switching of these signals between the various components of the head-end and data center 201.

Head-end transport portion 305 comprises a plurality of encoders 306-312, optional back-up encoder 313, multiplexor system 314, modulation system 318, up converters 319, and transport system 321. Encoders 305-312 and optional back-up encoder 313 receive interactive TV content signals from content reception, distribution, and switching portion 304 and encode the content signals into any of a variety of well known formats such as Motion Pictures Experts Group Standard 2 (MPEG-2), Motion Pictures Experts Group Standard 4 (MPEG-4), DivX, or any other format. Encoders 305 -312 and optional back-up encoder 313 each provide an individual encoded data stream representing the content signal of a single channel to multiplexor system 314.

Hot key generation system 315 is also connected with multiplexor system 314 of head-end transport 305. Hot key generation system 315 periodically polls a POP account of each user and generates a hot key signal to a specific user when that users POP account has received a new email message. According to one embodiment of the present invention, the user's POP account may be maintained by the service provider at the head-end and data center or elsewhere on the service provider's network. Alternatively, the user's POP account may be maintained elsewhere, such as on an Internet Service Provider's (ISP's) server. In this case, the user will provide the interactive TV service provider with access to the POP account of the ISP. Once a new email message has been detected and a hot key signal has been generated, hot key generation system 315 supplies the hot key signal to multiplexor system 314. Exemplary processes for generating hot key signals as may be performed by hot key generation system 315 will be discussed below with reference to FIG. 4.

Multiplexor system 314 may comprise a primary as well as an optional back-up multiplexor. Multiplexor system 314 combines the encoded content signals from encoders 305-312 and optional back-up encoder 313 and hot key signals from hot key generation system 315 to provide an output data stream. The output stream of multiplexor system 314 comprises the individual encoded data streams representing the content signals of the individual channels as well as any hot key signals.

The output stream of multiplexor system 314 may be applied to a modulation system 318. Modulation system 318 may comprise a primary as well as an optional back-up modulator. Modulation system 318 uses the output data stream of multiplexor system 314 to modulate a carrier frequency for transmission from the head-end system 201.

Modulation system 318 supplies the modulated carrier signal to up converters 319. Up converters 319 may comprise primary as well as optional back-up converters. Additionally, up converters 319 may comprise multiple stages of converters. The function of up converters 319 is to increase the modulated carrier frequency to a range that is suitable for transmission. Up converters 319 then transmit the modulated carrier signal from head-end and data center 201 via network 320 to users.

Optionally, or in addition to modulation system 318, the output of multiplexor system 314 may be applied to transport system 321 that may comprise a primary as well as an optional back-up transport system. The function of the transport system 321 is to prepare the output stream of multiplexor system 314 for transmission over network 322. That is, transport system 321 places the output stream of multiplexor system 314 into a format and protocol appropriate for network 322. For example, the output stream of multiplexor system may be placed into Internet Protocol (IP) packets or placed into an Asynchronous Transfer Mode (ATM) channel by transport system 321.

FIG. 4 is a flowchart illustrating head-end and data center processing for adding hot key signals to a transmitted signal according to one embodiment of the present invention. This process may be performed by a system such as the hot key generation system of the head-end and data center described above with reference to FIG. 3 or any other system with similar capabilities.

First, at decision block 400, the system determines whether a hot key signal should be sent to a specific user. This determination may be based on periodically polling a POP account of each user. According to one embodiment of the present invention, the user's POP account may be maintained by the service provider at the head-end and data center or elsewhere on the service provider's network. Alternatively, the user's POP account may be maintained elsewhere, such as on an Internet Service Provider's (ISP's) server. In this case, the user provides the interactive TV service provider with access to the POP account of the ISP by providing information such as the server name or IP address, user name, password, etc. that the service provider may use to access the user's account.

If a new mail message is found by polling the users' accounts, a hot key signal may be generated at processing block 405. According to one embodiment of the present invention, the hot key signal may comprise a special purpose Internet Protocol (IP) packet as described below with reference to FIG. 5. Alternatively, the hot key signal may be any other type of digital signal or packet suitable for transmission over the type of network being used and capable of carrying information similar to that shown in FIG. 5.

Finally, at processing block 410, the hot key signal is inserted into the content signal. That is, the hot key IP packet or other signal is multiplexed with the content data stream as described above with reference to FIG. 3.

FIG. 5 is a diagram illustrating one possible format for a hot key data packet according to one embodiment of the present invention. This example illustrates an IP data packet 500. The IP data packet includes a header 501 and a body 502.

Header 501 includes a number of fields 503-511 that are typically found in IP data packets. These fields include a source port 503, a destination port 504, a sequence number 505, an acknowledgement number 506, a data offset 507, a reserved field 508, a window field 509, checksum data 510, and an urgent pointer 511. It should be noted that such an IP data packet may be sent to multiple address using IP multicasting. Multicasting therefore allows efficient transmission of the hot key signals from the head-end and data center to users.

Body 502 may also include fields 512 and 515. These fields may include a hot key type 512 and a message field 515. In various applications, the number of fields used, size of the fields, type of data presented, format of the data, content of the fields, etc. may vary. For example, in some cases not all of the fields presented here may be used. In other cases, additional data may be presented such as additional graphical or textual information. Additionally, the data may be presented in a wide variety of formats such as plain American Standard Code for Information Interchange (ASCII) text, other binary representations or even encrypted.

Regardless of format, hot key type field 512 may represent the type of hot key signal being used. For example, the hot key signal represented by IP data packet 500 may indicate that alternate content is available on another channel or on a web site. Alternatively, the hot key signal may indicate that alternate content is available to be cached on the user's terminal device. In this example, hot key type field 512 will indicate that this is a message notification hot key.

Message field 515 may include additional textual or graphical information regarding the hot key or the email message. For example, the message field 515 may contain the text of the email message to be displayed to the user if he so chooses as described above. This message may be presented to the user automatically or at his option to help the user decide whether to accept or decline the hot key. Alternatively, message field 515 may contain only header information from the email message indicating, for example, the source of the email, the subject of the email and perhaps the time and date. According to yet another alternative, the message field 515 may simply contain a textual or graphical indication to the user the he has a new email message.

FIG. 6 is a block diagram of a user side system to provide a user with an email message responsive to selection of an embedded hot key according to one embodiment of the present invention. As discussed above, the user side system may vary significantly. The user side system comprising a terminal device, STB, Gateway or similar device performs functions such as exchanging messages (including video-related data) over a network with head-end and data center, receiving messages from a user input device, such as a hand-held remote control unit, translating video signals from a network-native format into a format that can be used by televisions or other display devices, providing a video signal to televisions or other display devices, and other functions.

The functionality of the user side system may reside in a stand-alone device, literally a box that can be placed on, or at least near, the television, that is similar in outward form to conventional devices for receiving cable programs. The user side system functionality could alternatively be performed by hardware resident elsewhere, such as within the television or display console, or by any suitably equipped terminal device. Since the hardware may be proprietary to the service provider and may generally be a physically independent device, the term set top box is used here, but any type of terminal device with similar functionality may be used.

In the example illustrated in FIG. 6, the user side system comprises an STB 208. STB 208 comprises tuner, receiver, demodulator 601, demultiplexor 602, decoder 603, graphics processor 604, central processing unit (CPU) 605, optional hard disk drive 606 or other mass storage device, memory 607, and various possible inputs and outputs 608.

Tuner, receiver, demodulator 601 receives signals from the service provider network 204 over any of a variety of media as discussed above. Specifically, tuner, receiver, demodulator 601 receives signals of a frequency band to which it is tuned and demodulates the signals to remove content signals from a carrier signal if any. Demodulated content signals are then supplied by tuner, receiver, demodulator 601 to demultiplexor 602.

Demultiplexor 602 receives the demodulated content signals from tuner, receiver, demodulator 601 and separates the content into multiple data streams representing various channels. The multiple data streams are then supplied as an input to decoder 603.

Decoder 603 receives the multiple data streams from demultiplexor 602 and decodes or decompresses the data streams using an appropriate algorithm. For example, if the head-end and data center compressed the video signals into an MPEG-2 data stream, decoder 603 will decode the MPEG-2 data stream from demultiplexor 602 to form a standard video signal. The video signal from decoder 603 is then supplied to graphics processor 604.

Graphics processor 604 receives the decoded video signals from decoder 603 and processes the video signals to reduce noise, provide amplifications, etc. Processed video signals from graphics processor 604 are supplied to input/output module 608. Input/output module 608 may provide a variety of possible output types. For example, outputs may include but are not limited to Audio/Video (A/V), Radio Frequency (RF), Sony/Phillips Digital Interface (SPDIF), Universal Serial Bus (USB), and others.

Input/output module 608 also receives control signals from the user. These control signals are typically InfraRed (IR) or Radio Frequency (RF) signals from a remote control unit. Control signals from the user are then fed back from input/output module 608 to Central Processing Unit (CPU) 605.

CPU 605 executes instructions stored in memory 607. Memory 607 may comprise a Random Access Memory (RAM) such as flash memory, or other non-volatile memory. The instructions stored in memory 607, when executed by CPU 605 cause CPU 605 to perform various functions such as controlling the various elements of STB 208, receiving hot key signals, and presenting email messages as will be described below with reference to FIG. 7.

Generally, a hot key signal will be received at tuner, receiver, and demodulator 601 along with and embedded in content signals from the head-end and data center and transmitted over service provider network 204. CPU 605 monitors the demultiplexed data streams from demultiplexor 602 for the presence of relevant hot key signals.

STB 208 may also contain an optional hard disk drive 606 or other mass storage device. Hard disk drive 606 allows STB 208 to cache content for later viewing by the user.

FIG. 7 is a flowchart illustrating processing on a user side system for providing a user an email message responsive to selection of an embedded hot key according to one embodiment of the present invention. This process may be performed by a system such as described above with reference to FIG. 6 or any other system with similar capabilities.

First, at processing block 700, the system receives a hot key signal from the service provider's network. As discussed above, the hot key signal may be in the form of a specialized IP packet or another type of signal embedded in the content signal from the service provider.

At decision block 705 a determination is made as to whether the hot key signal is relevant to the particular user. Since numerous hot key signals may be transmitted at any particular time, the signals may be filtered before being presented to the user. Such filtering may be based on any number of possible algorithms and criteria. For example, only hot key signals directed to this particular user may be considered relevant. This determination may therefore be based on a destination IP address or other destination information depending on the exact format of the hot key signal. Additionally, hot key signals may be filtered based on the source address, subject line, other header information, or based on the content of the message. Regardless of the algorithm or criteria used to judge relevance, if the hot key signal is determined at decision block 705 to not be relevant, no further processing is performed.

If the hot key signal is determined at decision block 705 to be relevant to the user, a hot key icon or other indication is displayed to the user at processing block 710. As mentioned above, this indication may be in the form of an icon placed on the screen, a text message, a tone or even a verbal alert. Regardless of the exact form, some indication is given to the user that a hot key has been received.

At decision block 715 a determination is made as to whether the user has accepted the hot key. As discussed above, the user may use any of a variety of means to indicate acceptance of the hot key. For example, different single or even multiple buttons on a remote control may be pressed by the user to accept or decline the hot key. According to one embodiment, a single “hot key button” may be present on the user's remote control that may be pressed by the user whenever a hot key icon is present on the television display. Regardless of the exact means of accepting or declining the hot key, if it is determined at decision block 715 the user did not accept the hot key, no further processing is performed.

If, at decision block 715, the user accepts the hot key, the email message may be displayed to the user at processing block 720. That is, the text of the email message may be read from the hot key signal such as the IP packet discussed above with reference to FIG. 5. As discussed above with reference to FIG. 1, the email message may be presented in a full screen against a blank background. Alternatively, the email may be superimposed on the original content display, presented in a picture-in-picture display, scrolled across a textbox at the bottom or top of the display, etc.

At decision block 725 a determination is made as to whether the user has finished reading the email message. This determination may be based on any of a variety of possible criteria. For example, the user may press a button or series of buttons on a remote control to indicate that he has finished viewing the message. Alternatively, the user may use a mouse or other pointing device of a remote control to select a graphic on the display to indicate that he has finished viewing the message. In another example, the email message may simply time out or expire after some amount of time.

Once a determination is made at decision block 725 that the user is finished with the email message, a return process is entered at processing block 730. This return process may include simply returning the user to the previous content. Alternatively, the return process may comprise presenting to the user other email messages based on other hot key signals. Another alternative may include presenting a user with a number of choices of how to proceed.

What is claimed is:

1. A method comprising:
determining whether to inform a user of an interactive television service of receipt of an email message;
responsive to determining to inform the user of the receipt of the email message, generating a hot key signal indicating availability of the email message; and
inserting the hot key signal into a content signal transmitted to the user from an interactive television service provider via a network with which the user and the interactive television service provider are connected.

2. The method of claim 1, wherein determining whether to inform the user of the interactive television service of receipt of the email message comprises periodically polling a Post Office Protocol (POP) account of the user.

3. The method of claim 2, further comprising:
retrieving the email message from the POP account; and
sending the email message to the user as part of the hot key signal.

4. The method of claim 2, wherein the POP account is an account maintained by the interactive television service provider.

5. The method of claim 2, wherein the POP account is an account maintained by an Internet Service Provider (ISP) other than the interactive television service provider.

6. A method comprising:
receiving a hot key signal indicating receipt of an email message by a Post Office Protocol (POP) account of a user of an interactive television service;
determining whether the hot key signal is relevant to the user; and
responsive to determining the hot key signal is relevant to the user, displaying on a screen an indication that the hot key signal has been received.

7. The method of claim 6, further comprising responsive to receiving an indication that the hot key is accepted, presenting to the user the email message indicated by the hot key signal.

8. The method of claim 6, wherein determining whether the hot key signal is relevant to the user comprises determining whether a destination address for the hot key signal is an address of the user.

9. The method of claim 6, wherein the hot key signal comprises an Internet Protocol (IP) data packet.

10. The method of claim 9, wherein the IP data packet has a header portion and a body portion, the body portion having a data field containing the email message.

11. A system comprising:
a content reception, distribution, and switching portion connected with one or more content providers to receive and redistribute interactive television (TV) content;
a head-end transport portion connected with the content reception, distribution, and switching portion to and encode, multiplex and transmit content signals from the content reception, distribution, and switching portion over a network;
a hot key generation portion to determine whether to inform a user of an interactive television service of receipt of an email message, and responsive to determining to inform the user of the receipt of the email message, generate a hot key signal indicating availability of the email message.

12. The system of claim 11, wherein the head-end transport portion receives the hot key signal from the hot key generation portion, and multiplexes the hot key signal with the content signal.

13. The system of claim 11, wherein the hot key generation portion determines whether to inform the user of the interactive television service of receipt of the email message by periodically polling a Post Office Protocol (POP) account of the user.

14. The system of claim 13, wherein the hot key generation portion retrieves the email message from the POP account and includes the email message as part of the hot key signal.

15. The system of claim 13, wherein the POP account is an account maintained by the interactive television service provider.

16. The system of claim 13, wherein the POP account is an account maintained by an Internet Service Provider (ISP) other than the interactive television service provider.

17. A system comprising:
a tuner, receiver, and demodulator portion and a demultiplexor portion to receive a hot key signal indicating receipt of an email message by a Post Office Protocol (POP) account of a user of an interactive television service; and
a processor to determine whether the hot key signal is relevant to the user and, responsive to determining the hot key signal is relevant to the user, display on a screen an indication that the hot key signal has been received.

18. The system of claim 17, wherein the processor, responsive to receiving an indication that the hot key is accepted, presents to the user the email message indicated by the hot key signal.

19. The system of claim 17, wherein the processor determines whether the hot key signal is relevant to the user based on whether a destination address for the hot key signal is an address of the user.

20. The system of claim 17, wherein the hot key signal comprises an Internet Protocol (IP) data packet.

21. The system of claim 20, wherein the IP data packet has a header portion and a body portion, the body portion having a data field containing the email message.

22. A machine-readable medium having stored thereon a series of instructions, the instructions, when executed by a processor, cause the processor to:
determine whether to inform a user of an interactive television service of receipt of an email message;
responsive to determining to inform the user of the receipt of the email message, generate a hot key signal indicating availability of the email message; and
insert the hot key signal into a content signal transmitted to the user from an interactive television service provider via a network with which the user and the interactive television service provider are connected.

23. The machine-readable medium of claim 22, wherein determining whether to inform the user of the interactive television service of receipt of the email message comprises periodically polling a Post Office Protocol (POP) account of the user.

24. The machine-readable medium of claim 23, wherein the instructions further cause the processor to:
retrieve the email message from the POP account; and
send the email message to the user as part of the hot key signal.

25. The machine-readable medium of claim 23, wherein the POP account is an account maintained by the interactive television service provider.

26. The machine-readable medium of claim 23, wherein the POP account is an account maintained by an Internet Service Provider (ISP) other than the interactive television service provider.

27. A machine-readable medium having stored thereon a series of instructions, the instructions, when executed by a processor, cause the processor to:
receive a hot key signal indicating receipt of an email message by a Post Office Protocol (POP) account of a user of an interactive television service;
determine whether the hot key signal is relevant to the user; and
responsive to determining the hot key signal is relevant to the user, display on a screen an indication that the hot key signal has been received.

28. The machine-readable medium of claim 27, further comprising responsive to receiving an indication that the hot key is accepted, presenting to the user the email message indicated by the hot key signal.

29. The machine-readable medium of claim 27, wherein determining whether the hot key signal is relevant to the user comprises determining whether a destination address for the hot key signal is an address of the user.

30. The machine-readable medium of claim 27, wherein the hot key signal comprises an Internet Protocol (IP) data packet.

31. The machine-readable medium of claim 30, wherein the IP data packet has a header portion and a body portion, the body portion having a data field containing the email message.
